(19) United States
(12) Patent Application Publication
(10) Pub. No.: US 2017/0215116 A1
(43) Pub. Date: Jul. 27, 2017

(54) METHODS AND APPARATUS TO PREVENT POOR QUALITY HANDOFF DECISIONS BY MOBILE NETWORKS

(71) Applicant: QUALCOMM Incorporated, San Diego, CA (US)

(72) Inventors: Pavan Siravuru, Basingstoke (GB); Simon Walke, Basingstoke (GB); Manmohan Rawat, Farnborough (GB); Awnit Kumar, Reading (GB); Mungal Singh Dhanda, Slough (GB); Naresh Babu Vungarala, Hyderabad (IN); Ravi Kanth Kotreka, Hyderabad (IN)

(21) Appl. No.: 15/005,755

(22) Filed: Jan. 25, 2016

(51) Int. Cl. H04W 36/00; H04B 17/336; H04B 17/327; H04W 36/30

(52) U.S. Cl. CPC H04W 36/0094; H04W 36/0061; H04W 36/30; H04B 17/336; H04B 17/327

(57) ABSTRACT

Disclosed are methods and apparatus to prevent poor quality handoff decisions in mobile networks. The methods and apparatus effectuate a determination whether a predetermined condition concerning a cell has occurred as detected in the mobile device, such as unsuccessful handoff or a signal to noise ratio being less than a certain amount. Based on such determinations, poor quality handoff decisions can be realized by modifying or configuring the measurement report message to be sent to the serving network where the measurement report is configured to omit information concerning those cells not meeting the predetermined condition. Accordingly, these cells will not be considered in handoff decisions, thus increasing the quality of such decisions.

### BACKGROUND

Field

The present disclosure relates generally to methods and apparatus for making handoff decisions, and more specifically for preventing poor quality handoff decisions in a mobile network.

Background

In mobile networks, such as GSM or Universal Mobile Telecommunications System (UMTS) systems, when cells are heavily loaded there is a possibility that the network may not entertain uplink requests from mobile devices (e.g., User Equipment (UE) or Mobile Stations (MS)). Thus, in a connected mode such non-entertained requests could lead to handoff failures when the mobile devices are handing off or over to another cell (Note: the terms “handoff” and “handover” used herein are synonymous as meaning the transfer of a UE or MS for wireless communication from one cell to another cell).

During a connected mode, a UE will perform continuous measurements of Neighbor Cells (NCell) provided to it by the network (NW) and then report the measurements in link quality messages (e.g., Measurement Reports) back to NW over uplink control channels, such as the Slow Associated Control Channel (SACCH) in GSM. A UE will also maintain information relating to the received signal strength (e.g., RxLev) of all cells in an internal list of neighboring cells (NCell list), which is typically ordered from the highest to lowest maintained signal strength values. During a voice call the UE will decode the NCELL Synchronization Channel (SCH) in sequential order of the cells in its NCell list. If the NCELL SCH decode is successful then the UE stores identification information of the cell (e.g., Base Station Identity Code (BSIC) of the NCell against the NCell Absolute Radio Frequency Channel Number (ARFCN)) and reports back the RxLev in the measurement reports to the NW, which typically include the six cells having the top RxLev values. The handoff procedure is then triggered by the NW based on the measurement Reports sent from the UE.

In currently known implementations, however, it has been observed that the ordering and reporting of NCells based solely on the received signal strength (RxLev) values while the UE is in connected mode may not an ideal approach. For example, if a cell in the measurement report has a good or even best RxLev value, but is nonetheless heavily loaded, there is a possibility that the network will not entertain uplink requests from mobile devices leading to handoff failure, as mentioned above. It has also been observed that the top neighboring cell reported in a measurement report might have a good or even best RxLev, but the signal to noise ratio (SNR) is very low (possibly less than <5 dB) when compared to other entries in the NCell list. The SNR represents the quality of the downlink channel of the cell. Thus, eventually based on the reports from UE, when the network decides to handover the voice call to the top most NCell, there is a possibility that the UE might experience CRC errors on the traffic (TCH) and control (FACCH, SACCH, SDCCH) channels in the new cell leading to Radio link failure and call drop. Thus, there is a need for methods and apparatus in a UE that can better avoid such poor quality handoff decisions.

### SUMMARY

According to an aspect of the present disclosure, a method for use in a mobile device is disclosed including determining whether a predetermined condition concerning a cell has occurred as detected in the mobile device. The method further includes updating a neighbor cell list in the mobile device with at least cell identifying information concerning the cell received from a serving network, and then storing the cell identifying information if the predetermined condition is met. Further, the method includes configuring a measurement report message to be sent to the serving network based on the stored information, wherein the measurement report is configured to omit the stored information concerning cells not meeting the predetermined condition.

In another aspect, a mobile station apparatus is disclosed featuring at least one processor configured to determine whether a predetermined condition concerning a cell has occurred as detected in the mobile device. The apparatus is further configured to update a neighbor cell list in the mobile device with at least cell identifying information concerning the cell received from a serving network. The apparatus is also configured to store the cell identifying information if the predetermined condition is met. Additionally, the apparatus is configured to configure a measurement report message to be sent to the serving network based on the stored information, wherein the measurement report is configured to omit information concerning cells not meeting the predetermined condition.

According to still another aspect, a wireless device is disclosed featuring means for determining whether a predetermined condition concerning a cell has occurred as detected in the mobile device. The device further includes means for updating a neighbor cell list in the mobile device with at least cell identifying information concerning the cell received from a serving network, and means for storing the cell identifying information if the predetermined condition is met. Additionally, the wireless device includes means for configuring a measurement report message to be sent to the serving network based on the stored information, wherein the measurement report is configured to omit information concerning cells not meeting the predetermined condition.

In yet another aspect, a computer program product including a computer readable medium is disclosed. The medium includes code for causing a computer to determine whether a predetermined condition concerning a cell has occurred as detected in a mobile device. Also, the medium includes code for causing a computer to update a neighbor cell list in the mobile device with at least cell identifying information concerning the cell received from a serving network, and code for causing a computer to store the cell identifying information if the predetermined condition is met. Furthermore, the medium includes code for causing a computer to configure a measurement report message to be sent to the serving network based on the stored information, wherein the measurement report is configured to omit information concerning cells not meeting the predetermined condition.

### BRIEF DESCRIPTION OF THE DRAWINGS

FIG. 1 illustrates a wireless network environment in which the presently disclosed methods and apparatus may be implemented.

FIG. 2 illustrates a flow diagram of a method for use in a mobile device for modifying a measurement report by the device.

FIG. 3 illustrates a flow diagram of an exemplary method for modifying measurement reports in order to improve handoff of a UE.

FIG. 4 illustrates a flow diagram of another exemplary method for modifying measurement reports in order to improve handoff of a UE.

FIG. 5 illustrates a block diagram of an exemplary UE/MS that may employ aspects of the presently disclosed methods and apparatus.

FIG. 6 illustrates a block diagram of a mobile wireless device operable to effectuate the methodologies of FIGS. 2-4.

### DETAILED DESCRIPTION

To help avoid poor handoff decisions, the present disclosure provides methods and apparatus to improve handoff decisions. In particular, the present disclosure includes providing a way to modify the measurements reports, such that cells that have the potential for being nonresponsive are not reported to the network, effectively removing such cells from handoff consideration. In an aspect, the methods and apparatus provide for the creation of a blacklist database in a UE that stores data for information concerning those cells that do not entertain uplink requests (i.e., fail to effect a handoff). In particular, the data stored may include the Absolute Radio Frequency Channel Number (ARFCN) and the Base Station Identity Code (BSIC) for GSM systems, or UTRA Absolute Radio Frequency Channel Number (UARFCN) and Primary Scrambling Code (PSC) information for W-CDMA systems. When the measurement report is sent, the blacklist database is accessed and those cells found on the blacklist are omitted from the measurement report. Furthermore, in another aspect a determination is made of not only the RxLev, but also the Signal to Noise Ratio (SNR) of a cell. This additional SNR determination may be used to determine whether a cell should be omitted from the measurement report (e.g., added to a blacklist database), where cells with insufficient SNR are added to the database.

This stored information may then be used and updated intelligently during the connected mode of operation. In the connected mode, the present method and apparatus further provides ceasing to report measurement reports of these “blacklisted” cells to the network, which then may potentially prevent mobile devices from suffering from poor quality handoff decisions by the network.

It is first noted that the word “exemplary” is used herein to mean “serving as an example, instance, or illustration.” Any example described herein as “exemplary” is not necessarily to be construed as preferred or advantageous over other examples. Furthermore, although the present methods and apparatus may be described in connection with GSM systems and with terminology associated therewith, it is noted that the present disclosure is applicable to other wireless systems, such as WCDMA as one example.

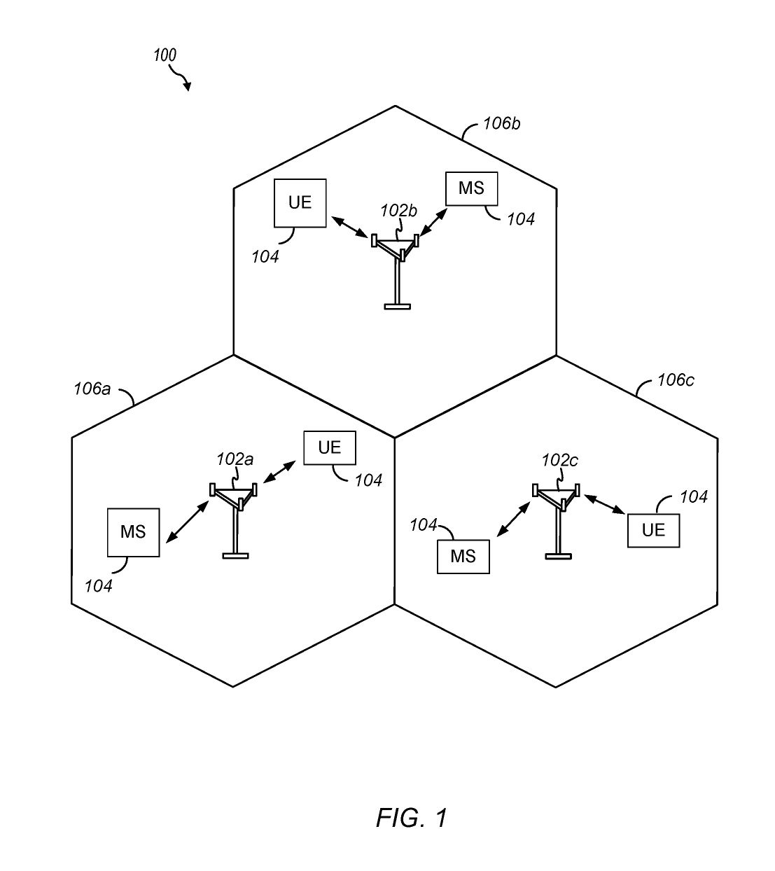

For the purpose of contextualization, FIG. 1 illustrates an example of a wireless network environment 100 in which the presently disclosed methods and apparatus may be implemented. The environment 100 is a multi-cell environments (e.g., coverage areas or cells 106a, 106b, 106c) where User Equipment (UE) or Mobile Stations (MS) 104 have mobility across the various cells 106 via handoffs from one cell to another, including utilizing an NCELL list as discussed previously.

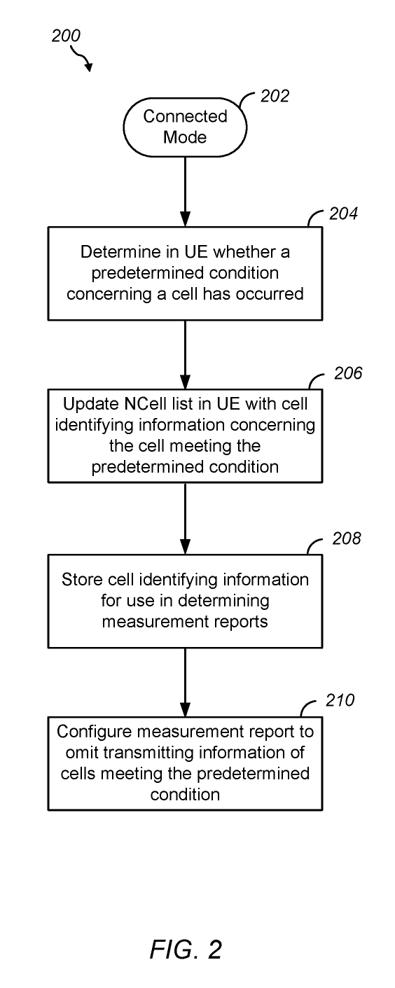

Base stations 102a, 102b, and 102c may also be referred to as, and may include some or all of the functionality of various transceiver devices across various technologies including devices termed NodeB, evolved NodeB (eNodeB or eNB), access point, base transceiver station (BTS), broadcast transmitter, etc. Additionally, the base stations 102 may be seen as representing NW elements, and may also be interchangeably referred to as the “Network” or “NW”. Each base station 102a, 102b, and 102c provides communication coverage for a particular geographic area. A base station 102 may provide communication coverage for one or more wireless communication devices 104. The term “cell” can refer to a base station 102 and/or its coverage area depending on the context in which the term is used. The base stations 102 can wirelessly communicate with the access terminals 104 via a base station antenna. The base stations 102 may each be implemented generally as a device adapted to facilitate wireless connectivity (for one or more access terminals 104) to the wireless communications system 100. The base stations 102 are configured to communicate with the access terminals 104 under the control of base station control (see FIG. 2) via multiple carriers. Each base station 102 can provide radio access communication coverage for a respective geographic area. The coverage area 106 for each base station 102 here is identified as cells 106a, 106b, and 106c, for example. The coverage area 106 for a base station 102 may be divided into sectors (not shown), which make up only a portion of the coverage area. The system 100 may include base stations 102 of different types (e.g., macro, micro, femto, and/or pico base stations).

One or more mobile stations 104 may be extant within the coverage areas 106. Each MS 104 may communicate with one or more base stations 102. An MS 104 may generally include one or more devices that communicate with one or more other devices through wireless signals. Although the GSM designation MS is used in this description, it will be appreciated that other known nomenclatures describing mobile wireless devices such as access terminal, user equipment (UE), subscriber station, mobile unit, subscriber unit, wireless unit, remote unit, mobile device, wireless device, wireless communications device, remote device, mobile subscriber station, mobile terminal, wireless terminal, remote terminal, handset, terminal, mobile client, client, or some other suitable terminology may be applicable.

Although the terminology MS and UE is used predominantly in this disclosure, other terms suitable for describing MS 104 could include a mobile phone, smart phone, wireless modem, personal media player, laptop computer, tablet computer, network enabled television, appliance, e-reader, digital video recorder (DVR), a machine-to-machine (M2M) device, and/or other communication/computing device which communicates, at least partially, via a radio access network.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (WCDMA) systems, time division multiple access (TDMA) systems, frequency division multiple access (FDMA) systems, orthogonal frequency division multiple access (OFDMA) systems, single-carrier frequency division multiple access (SC-FDMA) systems, 3rd Generation Partnership Project (3GPP) GERAN and Long Term Evolution (LTE) systems and spatial division multiple access (SDMA) systems.

FIG. 2 illustrates a method for use in a mobile device (e.g., UE or MS) for modifying a measurement report by the device. In particular, the method 200 features the configuration of the measurement report based on some predetermined condition concerning characteristics of the cell such as blacklisted cells due to failed HO or cells having a low SNR.

Method 200 begins when a UE is in a connected mode as indicated at block 202. The method then includes determining or detecting whether a predetermined condition (or conditions) concerning a cell has occurred as detected in a mobile device as shown at block 204. As will be explained in more detail later, the predetermined condition may be a cell with which handoff was unsuccessful or a cell having a signal to noise ratio below a predefined limit, as two examples.

After detection of the predetermined condition, a neighboring cell list (NCell list) is then updated in the mobile device with at least cell identifying information concerning the cell meeting the predetermined condition as indicated at block 206. In an aspect, the cell identifying information includes an ARFCN and BSIC (or UARFCH and PSC for WCDMA). The identifying information may then be stored for reference or use in determining the measurement reports sent from the UE to the network as illustrated by block 208. In another aspect, it may be possible that the identifying information need not be stored per se, but instead the information stored could be a proxy or some equivalent thereto that serves to identify which cell (or frequencies) will be considering in configuring the measurement report (e.g., cells for which their information is omitted from the report).

After storing the identifying information, the measurement report is then configured such that those stored cells meeting the predetermined condition are removed or omitted from the measurement report to be transmitted by the UE as illustrated by block 210. Omission of the stored cell(s) will cause the network not to direct the UE (or UEs) to handoff to those cells not meeting the predetermined condition. This, in turn, will increase the probability of poor handoff decisions increasing the quality of voice (and data) calls.

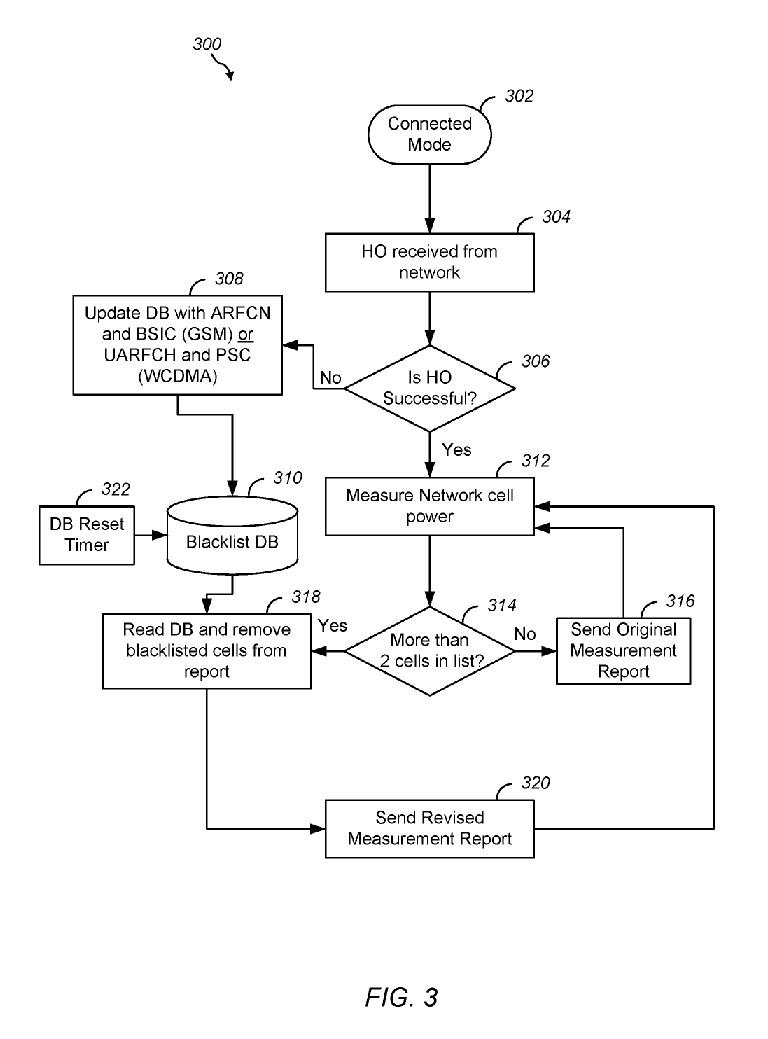

FIG. 3 illustrates an exemplary method for modifying measurement reports in order to improve handoff of a UE. The illustrated method 300, which may be implemented within a UE or MS, begins when a UE is in a connected mode 302. Next, a handoff (HO) request or message is received from the network as illustrated in block 304. If the HO is unsuccessful, as determined at decision block 306, flow proceeds to block 308 where a database, such as a CELL N database, is updated with the ARFCN and BSIC information of the cell for GSM. Alternatively, in the cased of WCDMA, as another example, the database is updated with UARFCH and PSC information. Based on the update in block 308, a blacklist database 310 is updated with the particular information concerning those cells with which the UE did not successfully handoff.

Alternatively at block 306, if the HO is successful, flow proceeds to block 312 where the UE measures the network cell power accordingly to the normal procedure for preparing a measurement report. After measurement of the network cell power, a determination is made whether there are two or more cells in the N CELL list as shown by decision block 314. If there is only one cell in the list, then flow proceeds to block 316 where the UE sends the original measurement report unmodified. Flow returns form block 316 to block 312 for further measurement of network cell power.

Should there be two or more cells in the neighboring cell list as determined at block 314, the blacklist database 310 is read, and those cells in the N CELL list that are also in the blacklist DB are removed from the measurement report as shown at block 318. In this manner, the measurement report is modified to omit measurements from those cells with which HO was unsuccessful, and thus increases the potential of successful HO with cells that were successful. The measurement report, as modified by omission of blacklisted cells, is sent to the network as shown at block 320, after which flow returns to block 312.

In an aspect, it is noted that the blacklist DB 310 may be reset at predetermined times. In an example, a database reset timer 322 may reset DB 310 after regular predetermined time intervals, or according to some other methodology to periodically reset the DB 310 based on other variables. Timer 322 also is useful as network conditions inevitably change over time and conditions on the blacklisted cells may improve, which would no longer result in the cell to be blacklisted.

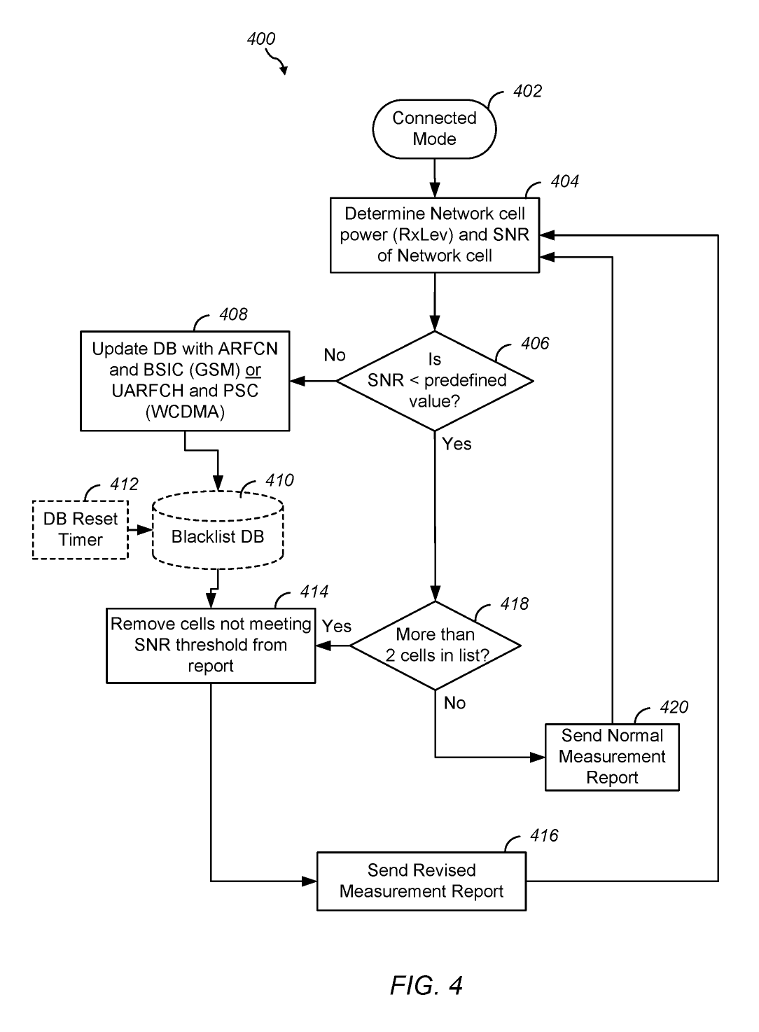

FIG. 4 illustrates another exemplary method for modifying measurement reports in order to improve handoff of a UE. In particular, method 400 modifies the measurement reports based on whether the SNR of a network cell is less than some predefined value or limit, by taking into consideration not only the network cell power of a cell, but also the signal to noise ratio (SNR). As may be seen at block 404 in FIG. 4, when a UE is in a connected state 402 a determination is made of both the RxLev and the SNR. The SNR of the NCELL's SCH decode is then checked to determine whether the cell has an SNR below a predefined value or limit as shown at decision block 406. In one example, the SNR limit could be defined at 5 dB. If the SNR is below the predefined limit, then the methodology may encompass effectively treating the cell as if the NCell SCH is not decoded, along with the ARFCN in the NCell list marked as “SCH is not decoded.” This may be seen in block 408.

In another aspect, the ARFCN and BSIC (or UARFCH and PSC information in the case of WCDMA) could be simply stored in a blacklist database (shown as an alternative example with blacklist database 410 and with a reset timer 412). Accordingly those cells in either the NCell list marked as not decoded (or stored in the blacklist DB) that have failed to meet the SNR threshold determined in block 406 are not included in the SACCH measurement report as illustrated in block 414. The modified measurement report is then sent as illustrated in block 416.

Similar to the methodology of FIG. 3, method 400 may also include determining whether two or more cells are in the N Cell list as shown by decision block 418. If not, then the normal measurement report is sent as shown by block 420. In the alternative, if two or more cells are in the N Cell list, then the database of cells not meeting the SNR threshold are considered at block 414, and a revised or modified measurement report is sent (block 416).

In an aspect, more frequent SNR measurements could be made of the top number of cells, such as six (6) Cells as it typical. To enhance the UE measurements communicated to the network, frequent SNR measurements of the top number of N Cells may be made based on the timelines of (SCH/FCCH of NCells) at the back end of TCH activity (Rx, TX & Power Monitor) and distributed during the whole duration of a TCH multi-frame (26 Frame duration). According to another aspect, the RxLev values in the Measurement reports could be adjusted based on the SNR measurements. In particular, a UE could adjust the values of RxLev of all the top number of NCells before reporting them to the network. For example, the RxLev values could be extrapolated based on the SNR measurements performed by the UE so as to steer the network to handover the UE to the NCell having a high SNR and a high RxLev instead of a cell having a high RxLev, but a low SNR.

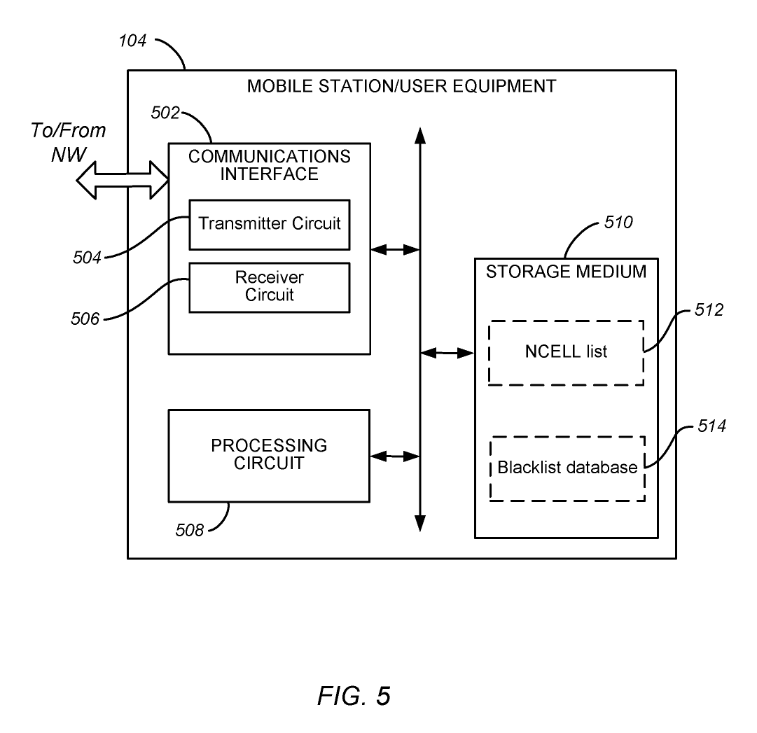

FIG. 5 illustrates a block diagram of an exemplary UE/MS that may employ aspects of the presently disclosed methods and apparatus. The UE/MS 104, which is a device operational in the context of FIG. 1 as one example, includes a communications interface 502 for wireless communication with the network, such as base station 102. Interface 502 includes receiver and transmitter circuits 504 and 506, respectively. The UE/MS 104 also includes a processing circuit 508 and a storage medium 510. The various illustrated parts 502, 508, and 510 are communicatively coupled to each other, and are configured to communicate according to any of a number of suitable communication protocols.

Additionally, the storage medium 510 in UE/MS 104 is illustrated with databases, such as the neighboring cell list (512) and the blacklist database (514). It is noted that this structure is merely exemplary of one options, and that the databases, lists, or libraries could be stored in separate storage media or similar devices as well.

It is noted that the methods of FIGS. 2-4 may be implemented with one or more of the various portions of the MS/UE 104 illustrated in FIG. 5. It is noted also that the portions may be separate as illustrated, or could be incorporated on one chip, such as with a System on a Chip (SoC) structure, in a single modem chip, or other similar constructions. It is also noted that the MS/UE 104 may work in conjunction with the network, such as via a wireless interface to a base station (e.g., base station 102 in FIG. 1) to effect the disclosed methodologies. In aspect, however, the methodologies of FIGS. 2-4 are to be primarily executed within a MS/UE 104 such that the UE is modifying the measurement reports sent to the base station (and ultimately the network).

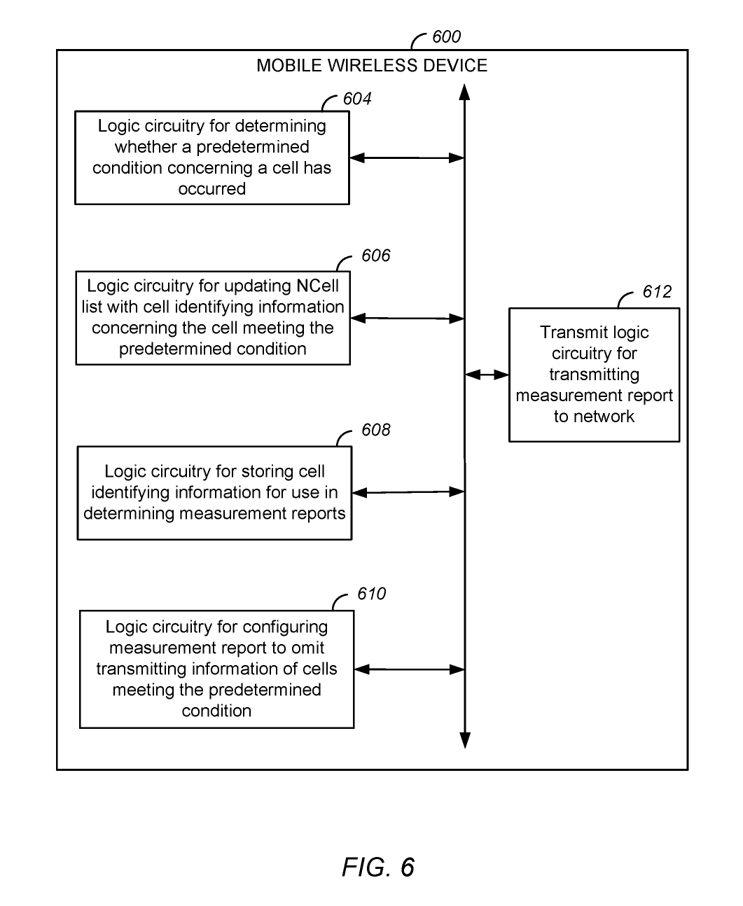

FIG. 6 illustrates a block diagram of a mobile wireless device 600 operable to effect the methodologies of FIGS. 2-4, for example. The device 600, which may be a UE or MS, or a portion thereof, includes various logic circuitry used to effect modification and transmission of a measurement report from the device 600 to a network (not shown). Device 600 includes logic circuitry 604 for determining whether a predetermined condition concerning a cell has occurred. The predetermined condition may include failure to handover as was discussed in connection with FIG. 3 or an SNR value below a target or limit amount as discussed in connection with FIG. 4, as examples.

This circuitry 604 works, at least in part, in cooperation with a receiver circuitry portion (or may be part of the receiver circuitry). Circuitry 604 is communicatively coupled with a logic circuitry 606 used for updating a neighbor cell list (NCell list) with cell identifying information concerning the cell meeting the predetermined condition. Further, device 600 includes a logic circuitry 608 for storing the cell identifying information for use in determining measurement reports to be sent from the device 600 to the network. It is noted that circuitry 608 may store the information in a database for reference by other circuitry in device 600 when determining the measurement report. For example, circuitry 608 may store cell identifying information in a black list database, as was discussed earlier.

A further logic circuitry 610 is configured to determining the measurement report such that information of those cells meeting the predetermined condition is omitted from the measurement report. Device 600 is also illustrated with a transmit logic circuitry 612 for transmitting the measurement report to the network.

As will be appreciated by those skilled in the art, the revised measurement report, by omitting the blacklisted cells collected in the database, provides a greater likelihood that the handoff decisions made by the network will be of higher quality and lead to less handoff failures. The present methods and apparatus provide a UE that avoids reporting cells which have low probability of sustaining the voice call. In this way, the UE will better avoid handing off to bad cells. Furthermore, the UE will have a reduced call drop rate in mobility. Additionally, in embodiments utilizing SNR analysis, the UE will be on the optimal cell in terms of SNR and signal strength.

It is understood that the specific order or hierarchy of steps in the processes disclosed is merely an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present method and apparatus.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present method and apparatus. Various modifications to these embodiments will be readily apparent to those skilled in the art, and the generic principles defined herein may be applied to other embodiments without departing from the spirit or scope of the method and apparatus. Thus, the present method and apparatus is not intended to be limited to the embodiments shown herein but is to be accorded the widest scope consistent with the principles and novel features disclosed herein.

What is claimed is:

1. A method for use in a mobile device comprising:
determining whether a predetermined condition concerning a cell has occurred as detected in the mobile device;
updating a neighbor cell list in the mobile device with at least cell identifying information concerning the cell received from a serving network;
storing the cell identifying information if the predetermined condition is met; and
configuring a measurement report message to be sent to the serving network based on the stored information, wherein the measurement report is configured to omit the stored information concerning cells not meeting the predetermined condition.

2. The method of claim 1 wherein determining that the predetermined condition is met comprises:
determining that a handoff to the cell is unsuccessful.

3. The method of claim 1, wherein the cell identifying information is stored in a blacklist database used for configuring the measurement report message.

4. The method of claim 3, further comprising:
resetting the blacklist database at predetermined time intervals.

5. The method of claim 1, wherein determining that the predetermined condition is met comprises:
analyzing a Signal to Noise Ratio (SNR) and the receive power level (RxLev) of the cell; and
determining that the predetermined condition is met when the SNR of the cell is lower than a predetermined value.

6. The method of claim 5, wherein the measurement report is configured to omit information about neighboring cells having an SNR lower than the predetermined value.

7. The method of claim 6, wherein the measurement report is configured to omit the neighboring cell information provided that there are other cells available having a better SNR and an RxLev above another predetermined value.

8. The method of claim 5, wherein the predetermined value is an SNR of 5 dB.

9. The method of claim 1, wherein the cell identifying information includes an Absolute Radio Frequency Channel Number (ARFCN) and Base Station Identity Code (BSIC) for a GSM network and an UTRA Absolute Radio Frequency Channel Number (UARFCN) and Primary Scrambling Code (PSC) for a WCDMA network.

10. A mobile station apparatus comprising:
at least one processor configured to:
determine whether a predetermined condition concerning a cell has occurred as detected in the mobile device;
update a neighbor cell list in the mobile device with at least cell identifying information concerning the cell received from a serving network;
store the cell identifying information if the predetermined condition is met; and
configure a measurement report message to be sent to the serving network based on the stored information, wherein the measurement report is configured to omit information concerning cells not meeting the predetermined condition.

11. The mobile station apparatus of claim 10 wherein determining that the predetermined condition is met comprises:
determining that a handoff to the cell is unsuccessful.

12. The mobile station apparatus of claim 10, wherein the cell identifying information is stored in a blacklist database used for configuring the measurement report message.

13. The mobile station apparatus of claim 12, wherein the at least one processor is configured to reset the blacklist database at predetermined time intervals.

14. The mobile station apparatus of claim 10, wherein the at least one processor is configured to determine that the predetermined condition is met by analyzing a Signal to Noise Ratio (SNR) and the receive power level (RxLev) of the cell, and determining that the predetermined condition is met when the SNR of the cell is lower than a predetermined value.

15. The mobile station apparatus of claim 14, wherein the measurement report is configured to omit information about neighboring cells having an SNR lower than the predetermined value.

16. The mobile station apparatus of claim 15, wherein the measurement report is configured to omit the neighboring cell information provided that there are other cells available having a better SNR and an RxLev above another predetermined value.

17. The mobile station apparatus of claim 14, wherein the predetermined value is an SNR of 5 dB.

18. The mobile station apparatus of claim 10, wherein the cell identifying information includes an Absolute Radio Frequency Channel Number (ARFCN) and Base Station Identity Code (BSIC) for a GSM network and an UTRA Absolute Radio Frequency Channel Number (UARFCN) and Primary Scrambling Code (PSC) for a WCDMA network.

19. A wireless device comprising:
means for determining whether a predetermined condition concerning a cell has occurred as detected in the mobile device;
means for updating a neighbor cell list in the mobile device with at least cell identifying information concerning the cell received from a serving network;
means for storing the cell identifying information if the predetermined condition is met; and
means for configuring a measurement report message to be sent to the serving network based on the stored information, wherein the measurement report is configured to omit information concerning cells not meeting the predetermined condition.

20. The wireless device of claim 19, wherein the means for determining that the predetermined condition is met further comprises:
means for determining that a handoff to the cell is unsuccessful.

21. The wireless device of claim 19, wherein the cell identifying information is stored in a blacklist database used for configuring the measurement report message.

22. The wireless device of claim 21, further comprising:
means for resetting the blacklist database at predetermined time intervals.

23. The wireless device of claim 19, further comprising:
means for analyzing a Signal to Noise Ratio (SNR) and the receive power level (RxLev) of the cell; and
means for determining that the predetermined condition is met when the SNR of the cell is lower than a predetermined value.

24. The wireless device of claim 23, wherein the measurement report is configured to omit information about neighboring cells having an SNR lower than the predetermined value.

25. The wireless device of claim 24, wherein the measurement report is configured to omit the neighboring cell information provided that there are other cells available having a better SNR and an RxLev above another predetermined value.

26. The wireless device of claim 23, wherein the predetermined value is an SNR of 5 dB.

27. The wireless device of claim 19, wherein the cell identifying information includes an Absolute Radio Frequency Channel Number (ARFCN) and Base Station Identity Code (BSIC) for a GSM network and an UTRA Absolute Radio Frequency Channel Number (UARFCN) and Primary Scrambling Code (PSC) for a WCDMA network.

28. A computer program product including a computer readable medium, the medium comprising:
code for causing a computer to determine whether a predetermined condition concerning a cell has occurred as detected in a mobile device;
code for causing a computer to update a neighbor cell list in the mobile device with at least cell identifying information concerning the cell received from a serving network;
code for causing a computer to store the cell identifying information if the predetermined condition is met; and
code for causing a computer to configure a measurement report message to be sent to the serving network based on the stored information, wherein the measurement report is configured to omit information concerning cells not meeting the predetermined condition.

29. The computer program product of claim 28, further comprising:
code for causing a computer to store the cell identifying information in a blacklist database used for configuring the measurement report message; and
wherein the determined predetermined condition is a determination that a handoff to the cell is unsuccessful.

30. The computer program product of claim 28, further comprising:
the code for causing a computer to determine whether a predetermined condition is met further comprising:
code for causing a computer to analyze a Signal to Noise Ratio (SNR) and the receive power level (RxLev) of the cell; and
code for causing a computer to determine that the predetermined condition is met when the SNR of the cell is lower than a predetermined value; and
wherein the measurement report is configured to omit information about neighboring cells having an SNR lower than the predetermined value.
